(19) United States
(12) Patent Application Publication
(10) Pub. No.: US 2011/0313791 A1
(43) Pub. Date: Dec. 22, 2011

(54) System and Method for a Health Campaign Manager

(75) Inventors: James R. Mault, Evergreen, CO (US); Adam Pellegrini, University Place, WA (US)

(73) Assignee: MYTELEHEALTHSOLUTIONS, LLC, La Jolla, CA (US)

(21) Appl. No.: 13/163,539

(22) Filed: Jun. 17, 2011

Related U.S. Application Data
(60) Provisional application No. 61/356,448, filed on Jun. 18, 2010.
(60) Provisional application No. 61/356,452, filed on Jun. 18, 2010.
(60) Provisional application No. 61/356,456, filed on Jun. 18, 2010.
(60) Provisional application No. 61/356,509, filed on Jun. 18, 2010.

(51) Int. Cl. G06Q 50/00

(52) U.S. Cl. 705/3

(57) ABSTRACT

A system and method for a campaign manager. The campaign manager is a complex health management toolset that allows a health organization to create, deploy, and monitor health programs targeted to a specific patient population by any health variable. The health programs are distributed through a campaign that can include a single health program or multiple health programs. As such, this provides a customized treatment to be offered to a specific population. Once the patient or group of patients enroll in a program, the health care professional of the health organization is able to monitor patient performance in the program using a triage dashboard.

### CROSS REFERENCE TO RELATED APPLICATIONS

The present application priority to and the benefit of U.S. Provisional Patent Application No. 61/356,448, entitled “System and Method for Connected Health Scheduling,” filed on Jun. 18, 2010, which is herein incorporated by reference in its entirety; claims priority to and the benefit of U.S. Provisional Patent Application No. 61/356,452, filed on Jun. 18, 2010, entitled “System and Method for a Health Campaign Manager,” which is herein incorporated by reference in its entirety; claims priority to and the benefit of U.S. Provisional Patent Application No. 61/356,456, filed Jun. 18, 2010, entitled “System and Method for a Single Session Assessment Tool,” which is herein incorporated by reference in its entirety; and claims priority to and the benefit of U.S. Provisional Patent Application No. 61/356,509, filed Jun. 18, 2010, entitled “System and Method for a Records Management and Permissioning System,” which is herein incorporated by reference in its entirety. The present application is related to of U.S. patent application Ser. No. 12/899,522, filed on Oct. 6, 2010, and entitled “System And Method For An Online Platform Distributing Condition Specific Programs Used For Monitoring The Health Of A Participant And For Offering Health Services To Participating Subscribers,” which is herein incorporated by reference in its entirety.

### BACKGROUND

1. Field

The present invention relates to providing health care and more specifically to the implementation of a health care campaign targeting a specific group of customers that would benefit from the campaign.

2. The Relevant Technology

The medical industry welcomes new ways to provide better care for individuals and for groups of individuals. Individuals may benefit from a health care campaign targeted directly to them, but it is difficult to identify every customer that would benefit from a health care campaign. It is desirous to enable a managed health care campaign that efficiently targets customers.

### SUMMARY

The present invention relates to the field of providing medical services. Specifically, embodiments of the present invention allow a health organization to create, deploy, and monitor health programs targeted to a specific patient population using any health variable. The health programs are distributed through a campaign that can include a single health program or multiple health programs. As such, this provides a customized treatment to be offered to a specific population.

In another embodiment, once a patient or a group of patients enroll in a program, a health professional can monitor their performance in the program using a triage dashboard. That is, responses and results relating to the patient is collected and analyzed within the system for health care management. These responses and results are stored in a database, and information contained therein can be displayed and accessed through a triage dashboard.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system providing a health campaign manager, in accordance with one embodiment of the present invention.

FIG. 2 is an illustration of a system providing for the monetization of a health campaign using tokens, in accordance with one embodiment of the present invention.

FIG. 3 is an illustration of a triage dashboard providing for the monitoring of patients' responses to a health program, and the distribution of alerts and notification regarding those responses, in accordance with one embodiment of the present invention.

### DETAILED DESCRIPTION

Reference will now be made in detail to embodiments of the present invention, a system and method for managing a health care campaign including one or more health programs targeted to a specific patient population by any health variable. While the invention will be described in conjunction with the described embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for systems and methods for the generation and distribution of a health care program to a targeted patient population. Also, embodiments of the present invention provide for the creation and management of a campaign consisting of one or more health care programs to facilitate the creation, targeted distribution, and management of the health care programs.

### Notation and Nomenclature

Embodiments of the present invention can be implemented on software running on a computer system. Other embodiments of the present invention can be implemented on specialized or dedicated hardware running on a computer system, or a combination of software and hardware running on a computer system. The computer system can be a personal computer, notebook computer, server computer, mainframe, networked computer, handheld computer, personal digital assistant, workstation, and the like. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “normalizing,” “providing,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the Application, the term “database” may be used to describe a location for storing information or data, and/or a mechanism for storing information or data. As such, “database” is interchangeable with the following terms: storage, data store, etc.

### Health Campaign Manager

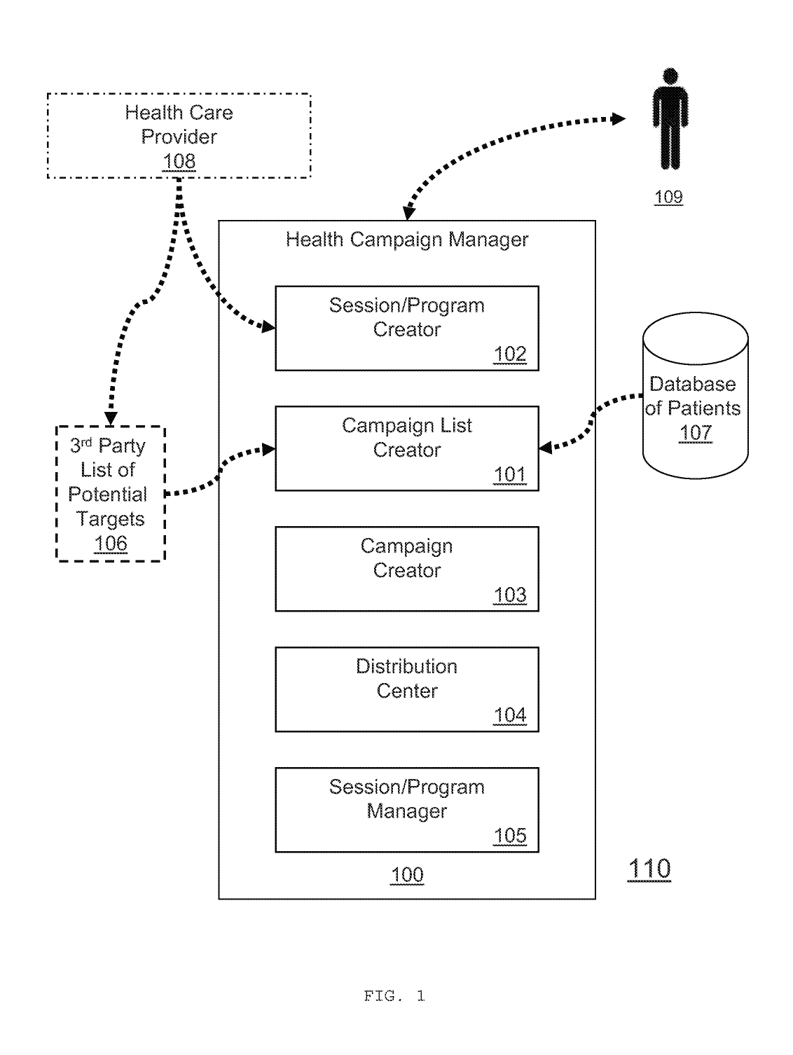

FIG. 1 is a diagram illustrating a health campaign manager 100 configured to support the creation, distribution and management of a health care campaign targeting one or more health care programs to a specific patient population, in accordance with one embodiment of the present invention. A health care provider (e.g., medical doctor, doctor group, labaratory, hospital, etc.) utilizes the health campaign manager 100 to distribute and manage health care programs that provide care to patients enrolled in the health care program.

In one embodiment, the health campaign manager 100 is implemented through a communication system, such as the internet. For instance, the health care provider communicates with the health campaign manager 100 to create the health care programs and/or campaign, distribute the health care programs, and manage the health care programs all through one or more communication networks.

As shown in FIG. 1, the health campaign manager 100 includes a program creator 102 for facilitating the generation of a health care session or program as dictated by a health care provider 108. More specifically, the health care provider 108 interfaces with the program creator 102 to create a health care program providing health care to a specific type of patient 109. For instance, the health care provider 108, such as ABC retail pharmacy, would like to launch a health care program, such as a diabetes management program (in conjunction with a new specialty pharmaceutical being launched to the market). As such, ABC pharmacy creates a diabetes management program that manages the care of diabetes of the patient 109. The diabetes management program may be in a question answer format, including questions asking whether the patient 109 has taken a sugar level reading today, inquiring as to glucosamine levels, whether the patient 109 has taken medication today, or inquiring as to the latest range of blood level readings. Answers as presented by the patient 109 are delivered back to the health campaign manager 100 for future processing and analysis.

Other health care programs may be created to include a specialty pharmaceutical program that is a health care program customized to promote the drug that is taken, or a wellness management program that provides general wellness health risk appraisals to focus on the overall health and wellness of a patient (e.g., general health, or diabetes health).

In addition, the health campaign manager 100 includes a campaign list creator 101 for creating a list of targeted customers or patients suitable for participating in a health care program associated with the health care provider 108. For instance, the health care provider 108 is able to present a list of potential targets 106 (e.g., in any table or file format) to the health campaign manager 100, wherein the list of potential targets 106 includes information related to patients that the health care provider 108 thinks may benefit from the health care program. In the example provided above, those on the list of potential targets 106 may be targeted as being at risk or having diabetes. Those on the list of potential targets 106 may have been identified using an ICD9 code for diabetes. As such, the campaign list creator 101 receives information about one or more potential targets suitable for participating in a health care program associated with the health care provider 108.

Also, the health care provider 108 may utilize the resources of the system associated with the health campaign manager 100. For instance, the health campaign manager 100 may be part of an overall system 110 that provides for managed care of patients. As such, the overall system 110 may include a database 107 storing information related to a plurality of patients. The information may include identifying information, as well as additional information relating to the general health of a corresponding patient 109. In the example provided above, patient information may include ICD9 codes, such as the ICD9 code for diabetes. In particular, the campaign list creator 101 accesses the database 107 of patients, and determines through parameter matching and analysis one or more patients from the database 107 that are suitable for participating in the health care program. For instance, the campaign list creator 101 may determine targeted customers using relevant variables (e.g., ICD9 codes for diabetes).

As such, in combination, the campaign list creator 101 generates a list of targeted customers comprising customers suitable for participating in the health care program. These targeted customers include those from the list of potential targets 106 provided by the health care provider, as well as the patients identified from the database 107 of patient information.

In one embodiment, employees of the health care provider 108 may also be associated with certain customers. For instance, in a campaign promoting a diabetes drug to targeted customers, the customers may be split into 3 groups. For efficiency, one group of pharmacists may be associated with the first group and follow up with those customers in that first group in the promoting the drug, a second group of pharmacists may be associated with the second group, etc.

The health campaign manager 100 also includes a campaign creator 103 for creating a campaign comprising one or more programs. That is, one or more programs may be grouped together, as selected by the health care provider 108, and delivered as a group to the customers in the list of targeted customers.

A distribution center 104 promotes the programs in the campaign. More specifically, the distribution center 104 distributes the campaign to customers in the list of targeted customers. Distribution may be in any suitable form. For example, the campaign may be distributed via email message, text message, or any suitable form that enables an invitation to participate in a program of a campaign to be distributed to customers in the list of targeted customers. As an example, the campaign may include an invitation (e.g., clickable link) to participate in a diabetes management program, a general health program, a specialty pharmaceutical drug program, a weight loss program, or any combination of the above. The invitation may include access to an interface that provides for immediate enrollment or additional information about each of the programs in the campaign.

The health campaign manager 100 also includes a program manager 105 for managing each of the programs after distribution. In particular, the program manager 105 receives responses to invitations inviting customers to participate in a health program. The program manager 105 manages the enrollment of patients to a particular health program. For instance, the invitation may include a link for the customer to provide information to the program manager 105. As such, once the patient clicks on the link provided, they interface with the program manager 105 and interact with options listed in the enrollment package.

In addition, after enrollment, the patient is presented with the ability to begin participating in each of his or her enrolled programs. Various communication methods are supported for having the patient participate in a program. For instance, the patient may communicate with the program manager through a communication network using a personal computer, a mobile device, a mobile computer, etc.

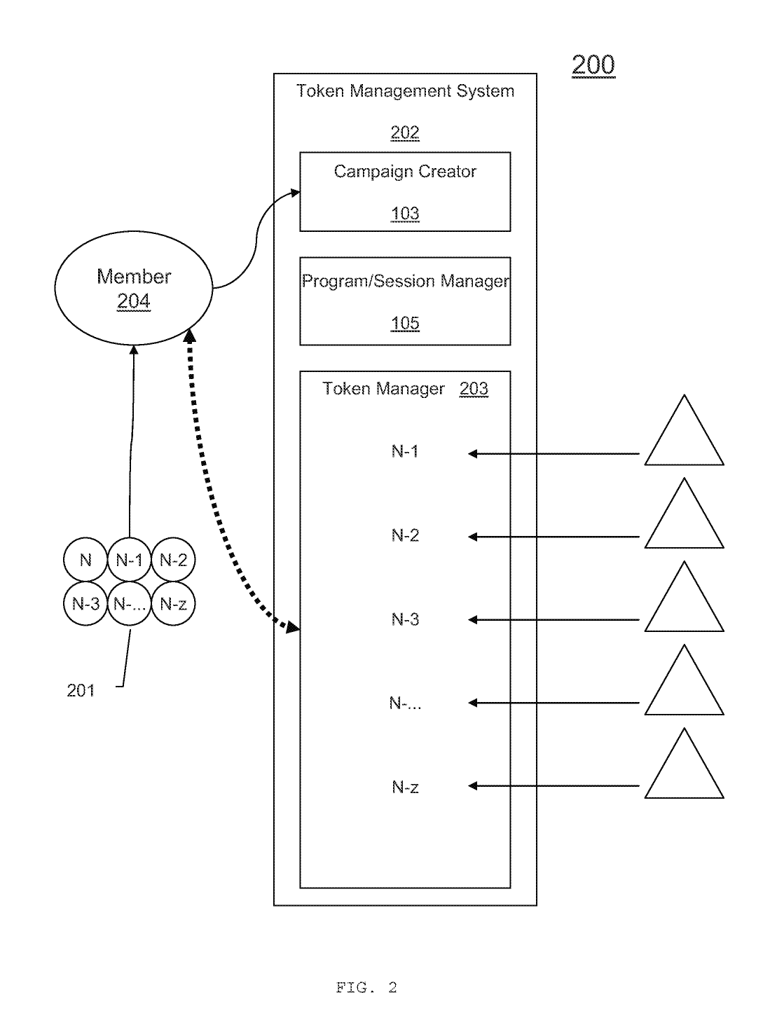

FIG. 2 is an illustration of a system 200 providing for the monetization of a health campaign using tokens 201, in accordance with one embodiment of the present invention. In particular, a token management system 202 includes the campaign creator 103 and program manager 105, previously described, as well as a token manager 203.

As shown, a member 204 (e.g., health care provider) of the system 200 providing overall health care, to include services provided by a health campaign manager 100, interacts with the campaign creator 103 to create a campaign including one or more health programs. For purposes of illustration, the member 204 is monetizing a campaign including one or more programs. For instance, the member 204 creates the campaign with the campaign creator 103. In addition, the member 204 pays for a credit of N tokens 201 to be assigned to the campaign.

Each token 201 represents one enrollment in a program. However, a token 201 may be of varying monetary values. For instance, one program may be worth US $25.00, whereas another program may be worth US $10.00. No matter the worth of the program, upon enrollment of the program, a token 201 is exchanged between the member 204 associated with the program and the health campaign manager 100. As shown, the token manager 203 manages the distribution of tokens 201 for a campaign for the member 204.

In one embodiment, the member 204 starts with N tokens 201 for a campaign. For instance, the member 204 pays to the health campaign manager 100 an amount for the N tokens 201. In another instance, accounting for the transfer of tokens 201 between the member 204 and the health campaign manager 100 is settled on a periodic basis. As each program is enrolled by a patient, a token 201 is exchanged between the member 204 and the health campaign manager 100 by the token manager 203. In particular, the token manager 203 diminishes the token credit in an account of the member 204. For instance, with a first enrollment, the account holds N-1 tokens 201, and so on.

In one embodiment, an administrator of the member 204 is able to view a current token 201 balance, and to see the exchange of tokens 201 between the member 204 and the token management system 202. As such, when the account runs low, this likely indicates a successful start to a campaign. The member 204 may choose to recharge or replenish the tokens 201 in the account, depending on the life of the campaign.

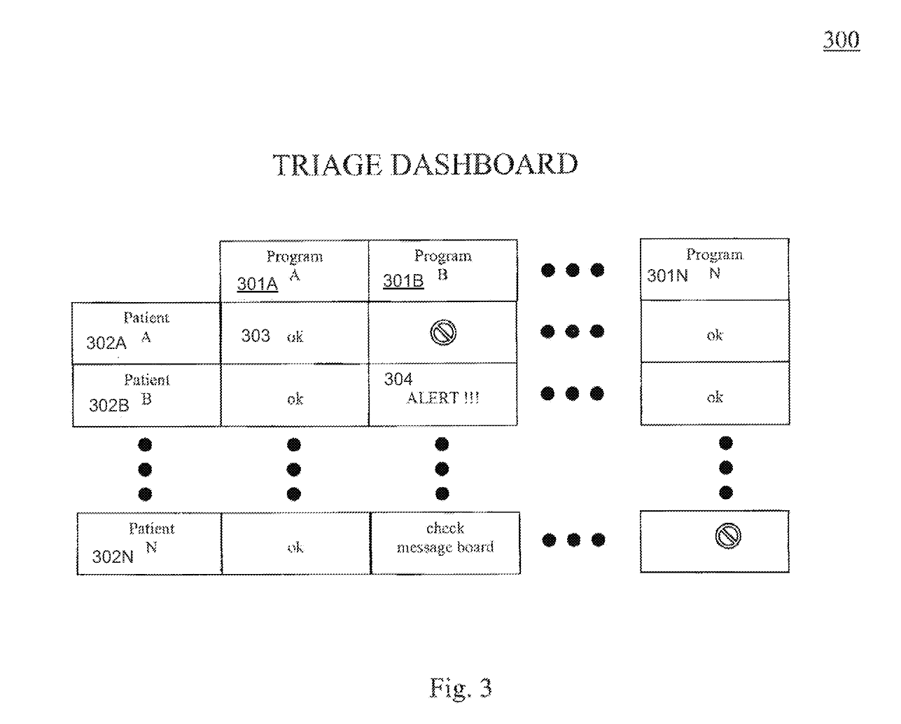

FIG. 3 is an illustration of a triage dashboard 300 providing for the monitoring of patients' responses to a health program, and the distribution of alerts and notification regarding those responses, in accordance with one embodiment of the present invention. After enrollment in a campaign, patients/customers begin to participate in the programs of the campaign. In the example provided in FIG. 3, N programs 301N are available in the campaign. Also, N patients 302N are participating in the N programs 301N. It is important to note that each patient may not necessarily participate in all of the offered programs. For example, in the embodiment of FIG. 3 patient A 301A is not participating in Program B 301B.

In one embodiment, the triage dashboard 300 displays a summary of responses to a program in the campaign by customers enrolled in the program. For instance, at a quick glance, a health care provider 108 may view the triage dashboard 300 and see that most of the patient's are doing well, as indicated by an “ok” message 303. However, some patients at a glance are not doing well, as will be described below.

In one embodiment, the information that is collected and displayed in the triage dashboard 300 is in compliance with the Health Insurance Portability and Accountability Act of 1996 (HIPAA) and its derivatives.

In the example introduced above where ABC retail pharmacy is implementing a campaign for promoting a health program tailored to a specialty pharmaceutical drug, as the patient/consumer participates in corresponding health sessions, the assigned pharmacist at ABC retail pharmacy for a particular customer will be able to monitor the responses on the triage dashboard 300. If any indications of concern are registered by the patient/consumer, the assigned pharmacist will be alerted through any suitable means, including either visually, by email or by text message.

In addition, the triage dashboard 300 may also display an alert 304, signifying to the member health care provider that attention to the corresponding patient, such as Patient B 302B in this example, is needed. In one implementation, the alert 304 is prominently displayed. For instance, the alert 304 may blink, be capitalized, be colored in an attention getting color, or may be connected with an audio signal, etc.

In still another embodiment, the alert 304 may be communicated to the member health care provider via any communication means suitable for relaying the urgency of the situation. For instance, an email message, text message, page, etc. may be generated and delivered to the appropriate parties.

A system and method for the creation, distribution, and management of a health care campaign including one or more health care programs targeted to a specific patient population by any health variable is thus described. While the invention has been illustrated and described by means of specific embodiments, it is to be understood that numerous changes and modifications may be made therein without departing from the spirit and scope of the invention as defined in the appended claims and equivalents thereof Furthermore, while the present invention has been described in particular embodiments, it should be appreciated that the present invention should not be construed as limited by such embodiments, but rather construed according to the below claims.

What is claimed:

1. A computer system configured to receive input from a list of potential targets and a patient information database, and provide a health campaign based on said list of potential targets and said patient information database, the computer system comprising at least one processor and a computer readable storage media having stored thereon instructions that, when executed cause the at least one processor to implement a health campaign manager comprising:
a program creator configured to generate at least one health care program dictated by a health care provider to provide care to a specific type of patient;
a list creator configured to receive a first input from said list of potential targets, said first input including information relating to a first group of one or more customers suitable for participating in said at least one health care program and further configured to access said patient information database and determine a second group of one or more customers suitable for participating in said at least one health care program, and further configured to generate a list of targeted customers, said list of targeted customers including said first group and said second group;
a campaign creator configured to create a campaign comprising said at least one health care programs;
a distribution center configured to distribute said campaign to said list of targeted customers; and
a program manager configured to manage said one or more health care programs of said health campaign.

2. The computer system of claim 1, wherein said health campaign manager further comprises:
a triage dashboard configured to display a summary of responses to said at least one health care program by said list of targeted customers.

3. The computer system of claim 2, wherein said triage dashboard displays an alert indicating a situation involving a customer among said targeted customers.

4. The computer system of claim 1, wherein said health campaign manager further comprises:
a token manager for managing a distribution of tokens for a campaign for the health care provider.

5. A computer implemented method for managing a health care campaign, the method comprising:
accessing a computer system having access to a database of patients;
receiving input indicating a type of patient for which to create a health care program;
causing said computer system to create said health care program customized for said input type of patient;
receiving a list of potential targets previously determined to benefit from said health care program;
causing said computer system to create a campaign list of targeted customers suitable for participation in said health care program based on said list of potential targets;
causing said computer system to create said health care campaign including at least said health care program; and
causing said computer system to distribute said health care campaign to a customer in said list of potential targets.

6. The computer implemented method of claim 5, further comprising:
receiving an input indicating a parameter associated with said health care program;
causing said computer system to access said database of patients;
causing said computer system to determine at least one patient from said database of patients, wherein said at least one patient is associated with said parameter; and
causing said computer system to modify said list of potential targets to include said at least one patient.

7. The computer implemented method of claim 6, further comprising:
receiving a response from said customer; and
outputting a summary of said response for perception by a user.

8. The computer implemented method of claim 6, wherein outputting a summary of a response displays an alert to a user indicating a situation associated with said customer.

9. The computer implemented method of claim 6, further comprising:
causing said computer system to distribute a plurality of tokens associated with said health care program;
receiving an indication that a customer has enrolled in said health care program;
causing said computer system to charge said health care campaign one of said plurality of tokens.

10. The computer implemented method of claim 9, the method further comprising:
receiving a payment for a first number of tokens;
causing said computer system to store said first number of tokens;
causing said computer system to reduce said first number of tokens to a second number of tokens; and
causing said computer system to store said second number of tokens.

11. A computer program product comprising a storage media having stored thereon computer instructions that when implemented by a computer processor of a computer system, causes the computer system to implement a method, the method comprising:
in response to receiving input indicating a type of patient for which to create a health care program, creating said health care program customized for said input for said type of patient;
in response to receiving a list of potential targets previously determined to benefit from said health care program, causing said computer system to create a campaign list of targeted customers suitable for participation in said health care program;
creating a campaign including at least said health care program; and
distributing said campaign to a customer in said list of potential targets.

12. The computer program product of claim 15, wherein said method further comprises:
in response to receiving an input indicating a parameter associated with said health care program, accessing a database of patients;
determining at least one patient from said database of patients, wherein said at least one patient is associated with said parameter; and
modifying said list of potential targets to include said at least one patient.

13. The computer program product of claim 6, wherein said method further comprises:
in response to receiving a response from said customer; outputting a summary of said response for perception by a user.

14. The computer program product of claim 6, wherein said outputting a summary of said response displays an alert to a user indicating a situation associated with said customer.

15. The computer program product of claim 6, wherein said method further comprises:
distributing a plurality of tokens associated with said health care program;
in response to receiving an indication that said customer has enrolled in said health care program, charging said health care campaign one of said plurality of tokens.

16. The computer program product of claim 9, wherein said method further comprises:
in response to receiving a payment for a first number of tokens, storing said first number of tokens;
reducing said first number of tokens to a second number of tokens; and
storing said second number of tokens.
